(19) United States
(12) Patent Application Publication
(10) Pub. No.: US 2025/0385850 A1
(43) Pub. Date: Dec. 18, 2025

(54) TELEMETRY-BASED DEVICE POWER CONSUMPTION PREDICTION

(71) Applicant: Cisco Technology, Inc., San Jose, CA (US)

(72) Inventors: Sean C. Pegado, Washington, DC (US); Corentin Marc Jean Dugue, San Francisco, CA (US); Michael Guggisberg, GLENDALE, CA (US); Corbin E. Jarrett, San Francisco, CA (US)

(21) Appl. No.: 18/741,599

(22) Filed: Jun. 12, 2024

(51) Int. Cl. H04L 43/08; H04L 41/16

(52) U.S. Cl. CPC H04L 43/08; H04L 41/16

(57) ABSTRACT

Devices, systems, methods, and processes for telemetry-based device power consumption prediction are described herein. Values of power consumption and telemetry parameters associated with a network device are collected over a time period. Using at least one telemetry parameter, various engineered parameters are generated. From all the collected telemetry parameters and the engineered parameters, a set of model parameters is selected for model development. A machine learning (“ML”) model is then trained to determine a correlation between the values of the set of model parameters and the power consumption of the network device. When the network device is in the field, device telemetry data is sensed. Based on the device telemetry data, values corresponding to the set of model parameters are determined and provided as input to a trained ML model. Device power consumption is predicted based on an output of the trained ML model for the input values.

The present disclosure relates to wireless networking. More particularly, the present disclosure relates to telemetry-based device power consumption prediction.

### BACKGROUND

Network devices like routers, switches, and access points are the backbone of modern communication systems. They play a vital role in facilitating data exchange and enabling connectivity across various computer networks, from local area networks to wide area networks. These devices are essential for managing and directing data traffic efficiently, ensuring seamless communication and collaboration within organizations and across the internet.

Given the critical role network devices play, it is important to monitor their health regularly. Moreover, as organizations increasingly prioritize environmental sustainability, it is beneficial to manage the carbon footprint of these network devices. Environmental sustainability involves conserving natural resources, ecosystems, and the environment as a whole. The amount of power a device consumes serves as an indicator of its health and carbon footprint. Thus, accurately measuring this power consumption can be leveraged for both monitoring device health and controlling its environmental impact.

### SUMMARY OF THE DISCLOSURE

Systems and methods for telemetry-based device power consumption prediction in accordance with embodiments of the disclosure are described herein.

In some embodiments, a device includes a processor and a memory communicatively coupled to the processor, wherein the memory includes a power management logic that is configured to collect a base dataset associated with a network device, wherein the base dataset includes a plurality of values of power consumption and a set of telemetry parameters associated with the network device collected over a time period, determine a training dataset from the base dataset, and train a machine learning model based on the training dataset, wherein the trained machine learning model is configured to predict device power consumption based on device telemetry data.

In some embodiments, the base dataset is collected based on one or more testing operations.

In some embodiments, the one or more testing operations are executed sequentially, and in each testing operation of the one or more testing operations, a set of values of the power consumption and the set of telemetry parameters is collected.

In some embodiments, at least one of the set of values is timestamped.

In some embodiments, the one or more testing operations are associated with variations in at least one of memory consumption, temperature, central processing unit (“CPU”) load, and power over Ethernet (“PoE”) draw associated with the network device.

In some embodiments, the set of telemetry parameters includes at least one of a motherboard temperature, a CPU temperature, a power sourcing equipment (“PSE”) junction temperature, a total memory capacity, a free memory capacity, an available memory capacity, and a CPU idle percentage, associated with the network device.

In some embodiments, the power management logic is further configured to execute one or more processing operations on the base dataset, and generate a processed dataset based on the execution of the one or more processing operations, wherein the training dataset is a subset of the processed dataset.

In some embodiments, the power management logic is further configured to generate one or more engineered parameters based on at least one of the set of telemetry parameters, and select a set of model parameters that includes the one or more engineered parameters and a subset of telemetry parameters of the set of telemetry parameters, wherein the training dataset includes one or more values of the power consumption and the set of model parameters associated with the network device collected over the time period.

In some embodiments, the training dataset includes one or more values of the power consumption and at least one of a motherboard temperature, a CPU temperature, a PSE junction temperature, a free memory capacity, a total CPU non-idle percentage, and a maximum CPU non-idle percentage, associated with the network device collected over the time period.

In some embodiments, the set of telemetry parameters includes a CPU idle percentage, and wherein the total CPU non-idle percentage and the maximum CPU non-idle percentage are determined based on the CPU idle percentage.

In some embodiments, the power management logic is further configured to determine a test dataset from the base dataset, and validate the trained machine learning model based on the test dataset.

In some embodiments, the power management logic is further configured to predict power consumed by the network device based on a set of telemetry values derived from the test dataset, and wherein the trained machine learning model is validated based on the predicted power and a power consumption value of the test dataset.

In some embodiments, the power management logic is further configured to determine an error associated with the trained machine learning model based on the validation of the trained machine learning model.

In some embodiments, the power management logic is further configured to tune the machine learning model based on the determined error.

In some embodiments, a power management logic is configured to receive device telemetry data, determine, based on the device telemetry data, a set of values of one or more telemetry parameters, provide the set of values as an input to a trained machine learning model, and predict device power consumption based on an output of the trained machine learning model for the set of values.

In some embodiments, the device telemetry data is configured to indicate at least one of device performance and device physical condition.

In some embodiments, the device telemetry data includes a plurality of values of at least one of a motherboard temperature, a central processing unit (“CPU”) temperature, a power sourcing equipment (“PSE”) junction temperature, a total memory capacity, a free memory capacity, an available memory capacity, and a CPU idle percentage.

In some embodiments, one or more telemetry parameters include at least one of a motherboard temperature, a CPU temperature, a PSE junction temperature, a free memory capacity, a total CPU non-idle percentage, and a maximum CPU non-idle percentage.

In some embodiments, one or more device features are controlled based on the predicted device power consumption.

In some embodiments, a method, includes collecting a base dataset associated with a network device, wherein the base dataset includes a plurality of values of power consumption and a set of telemetry parameters associated with the network device collected over a time period, determining a training dataset from the base dataset, and training a machine learning model based on the training dataset, wherein device power consumption is predicted by the trained machine learning model based on device telemetry data.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of an example training environment for machine learning model training in accordance with various embodiments of the disclosure;

FIG. 2 is a conceptual illustration of a machine learning model in accordance with various embodiments of the disclosure;

FIG. 3 is a schematic block diagram of an example environment for off-device power prediction in accordance with various embodiments of the disclosure;

FIG. 4 is a schematic block diagram of a network device in accordance with various embodiments of the disclosure;

FIG. 5 is a flowchart depicting a process for training a machine learning model for power consumption prediction in accordance with various embodiments of the disclosure;

FIG. 6 is a flowchart depicting a process for validating a machine learning model trained for power consumption prediction in accordance with various embodiments of the disclosure;

FIG. 7 is a flowchart depicting a process for predicting device power consumption in accordance with various embodiments of the disclosure; and

FIG. 8 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that facilitate the prediction of power consumption of network devices using hardware telemetry data of the network devices. Given the critical role of network devices in wireless networks, regular health monitoring is important. Further, as organizations prioritize environmental sustainability, managing the carbon footprint of these devices is beneficial. Power consumption indicates both device health and carbon footprint, so accurate measurement can be useful for monitoring device health and controlling environmental impact.

Conventionally, external power sensors monitor network device power consumption, but they are costly, bulky, and complex, making widespread use impractical. Integrating a current monitor into the device can be inaccurate, especially at low power levels. This approach also adds costs and design constraints. Power supply units (“PSUs”) with integrated monitoring are a solution, but they are expensive and unsuitable for smaller devices like access points and cameras, which use Power over Ethernet (“PoE”). External power monitors are large and pricey, practical mainly for lab settings, and they cannot provide real-time data. Real-time power consumption varies with internal factors like firmware and traffic load, and external factors like temperature and humidity, making lab-to-field extrapolations potentially biased.

To overcome the aforementioned issues with power consumption measurement, the present disclosure provides telemetry-based device power consumption prediction. In the present disclosure, a machine learning (“ML”) model is trained to determine the correlation between the device power consumption and the device telemetry data. In an example, the device telemetry data may correspond to hardware telemetry data of a device. The trained ML model can then be utilized to predict the power consumed by a network device deployed in the field based on the device telemetry data. In numerous additional embodiments, the device telemetry data may be configured to indicate at least one of device performance and device physical condition.

At a high level, the ML model training may include data collection and development of the ML model. The purpose of data collection can be to collect multiple data points with information about the state of a network device and its associated power consumption for training the ML model. In many embodiments, the ML model training may be executed in a lab setting.

A power manager may be configured to collect a base dataset associated with the network device. The base dataset may include a plurality of values of power consumption and a set of telemetry parameters associated with the network device collected over a time period. The set of telemetry parameters may include at least one of a motherboard temperature, a CPU temperature, a PSE junction temperature, a total memory capacity, a free memory capacity, an available memory capacity, and a CPU idle percentage, associated with the network device. The base dataset may be collected based on one or more testing operations. The one or more testing operations may be executed sequentially, and in each testing operation of the one or more testing operations, various values of the power consumption and the set of telemetry parameters can be collected. At least one value may be timestamped.

The power manager may be configured to execute one or more processing operations on the base dataset and generate a processed dataset. Further, the power manager may be configured to generate one or more engineered parameters based on at least one of the set of telemetry parameters. For example, a total CPU non-idle percentage and a maximum CPU non-idle percentage may be generated based on the CPU idle percentage. The total CPU non-idle percentage may be generated by subtracting a sum of CPU idle percentages of all CPU cores from 100*a number of cores. The maximum CPU non-idle percentage may be generated by subtracting the least CPU idle percentage among all cores from 100.

The power manager may be configured to select a set of model parameters for model development. In still yet more embodiments, the set of model parameters may include the one or more engineered parameters and a subset of telemetry parameters of the set of telemetry parameters. In an example, the set of model parameters may include the motherboard temperature, the CPU temperature, the PSE junction temperature, the free memory capacity, the total CPU non-idle percentage, and the maximum CPU non-idle percentage, associated with the network device.

The power manager may be configured to determine a training dataset and a test dataset from the base dataset (e.g., the processed dataset). The training dataset can be utilized to train the ML model, whereas the test dataset can be utilized to validate the trained ML model. The training dataset may thus include one or more values of the power consumption and the set of model parameters associated with the network device collected over the time period. For example, the training dataset may include one or more values, collected over the time period, of the power consumption, the motherboard temperature, the CPU temperature, the PSE junction temperature, the free memory capacity, the total CPU non-idle percentage, and the maximum CPU non-idle percentage associated with the network device. In other words, the training dataset may include exclusively the telemetry parameters that are selected for the model development. Similarly, the test dataset may include one or more values of the power consumption and the set of model parameters associated with the network device collected over the time period. For example, the test dataset may include one or more values, collected over the time period, of the power consumption, the motherboard temperature, the CPU temperature, the PSE junction temperature, the free memory capacity, the total CPU non-idle percentage, and the maximum CPU non-idle percentage associated with the network device. In other words, the test dataset may also include exclusively the telemetry parameters that are selected for the model development. The training and test datasets may correspond to subsets of the processed dataset.

The power manager may be configured to train an ML model based on the training dataset. In many further embodiments, the ML model may be trained using a supervised machine learning algorithm that trains a linear regression with elastic net regularization using cross-validation and features for the motherboard temperature, the CPU temperature, the PSE junction temperature, the free memory capacity, the total CPU non-idle percentage, and the maximum CPU non-idle percentage on the response power measurement. The ML model may be trained for device power consumption prediction. In other words, the trained ML model may be configured to predict device power consumption based on device telemetry data.

The trained ML model may be required to be validated prior to being implemented in the field. In the validation phase, the power manager may be configured to validate the trained ML model based on the test dataset. For example, the power manager may be configured to predict power consumed by the network device based on a set of telemetry values derived from the test dataset. The set of telemetry values may include values of the motherboard temperature, the CPU temperature, the PSE junction temperature, the free memory capacity, the total CPU non-idle percentage, and the maximum CPU non-idle percentage. The trained ML model can be validated based on the predicted power and a power consumption value of the test dataset. Based on the validation of the trained ML model, the power manager may be configured to determine an error associated with the trained ML model. In many additional embodiments, the error may correspond to mean absolute percentage error (“MAPE”). If the error is greater than a threshold value (e.g., the error is not acceptable), the ML model may require tuning. In still yet further embodiments, the power manager may be configured to tune the ML model based on the determined error. In several embodiments, the tuning of the ML model may include collecting a base dataset, selecting model parameters based on the base dataset, and re-training the ML model based on the model parameters. The re-trained ML model may further be re-validated. The tuning may be executed until the error is less than or equal to the threshold value (e.g., the error is acceptable). The power manager may thus obtain the trained ML model for device power consumption prediction.

During an implementation phase, the power manager may be configured to receive device telemetry data associated with a network device deployed in the field. Based on the device telemetry data, the power manager may be configured to determine a set of values of one or more telemetry parameters. The one or more telemetry parameters may include at least one of the motherboard temperature, the CPU temperature, the PSE junction temperature, the free memory capacity, the total CPU non-idle percentage, and the maximum CPU non-idle percentage. The one or more telemetry parameters can thus correspond to model parameters that are utilized for training the ML model. The power manager may be configured to provide the set of values as an input to the trained ML model. Thus, the power manager may be configured to predict the power consumption of the network device based on an output of the trained ML model for the set of values. One or more device features may be controlled based on the predicted device power consumption. The device features may correspond to various hardware and software features (e.g., access ports, interfaces, communication protocols, blinking lights, switching mechanisms, security techniques, quality of service, or the like).

Thus, in the present disclosure, telemetry data of a network device may be utilized for predicting the power consumed by the network device. The present disclosure thus provides a solution that can enable power consumption prediction without adding power sensors to the network devices. Consequently, the cost and size of the network devices can be reduced. Further, network devices having a simpler design with fewer components can be developed.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (“PCB”) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board, or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

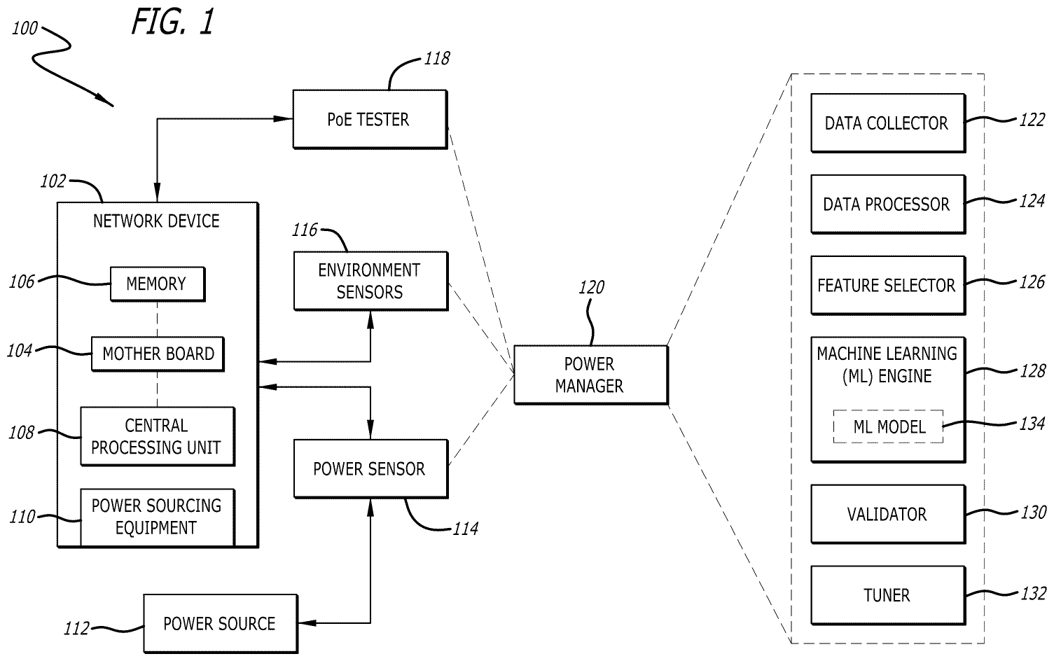

Referring to FIG. 1, a schematic block diagram of an example training environment 100 for machine learning (“ML”) model training in accordance with various embodiments of the disclosure is shown. The ML model may be trained to predict network device power consumption. In the present disclosure, network device telemetry data may be provided as input to the trained ML model to predict the network device power consumption.

Given the critical role network devices play in wireless networks, it is important to monitor the health of the network devices regularly. Moreover, as organizations increasingly prioritize environmental sustainability, it is beneficial to manage the carbon footprint of network devices. Environmental sustainability involves conserving natural resources, ecosystems, and the environment as a whole. The amount of power a device consumes serves as an indicator of its health and carbon footprint. Thus, accurately measuring this power consumption of network devices can be leveraged for both monitoring device health and controlling its environmental impact.

Conventionally, electric power sensors may be installed on network devices to monitor power consumption. However, these sensors come with drawbacks such as being costly, bulky, and intricate to develop. Consequently, outfitting all network devices with such sensors may not always be practical. Another alternative is integrating a current monitor directly into the network device, but this approach often yields inaccuracies, especially at low power consumption levels, due to limitations in the shunt resistor selection. Moreover, there can be power loss in the circuit between the device input and the power sensor, which goes unmeasured, leading to reporting errors. Incorporating a power sensor can also impose additional costs and design constraints, which may not always be feasible. While power supply units (“PSUs”) with integrated power monitoring offer a solution, they can be expensive and not suitable for smaller devices like access points and cameras, which are typically powered via Power over Ethernet (“PoE”) and lack a dedicated PSU. Alternatively, users can resort to monitoring power consumption using external power monitors, but these are often large and pricey, making them impractical for everyday use. Although external power monitors find utility in lab settings to gauge power consumption limits, their broad ranges and inability to provide real-time data hinder their effectiveness. Real-time power consumption can be influenced by both internal factors like firmware version and traffic load, as well as external factors like temperature and humidity. Therefore, extrapolating lab power consumption measurements to field devices may introduce biases due to these dependencies.

To overcome the aforementioned issues with power consumption measurement, the present disclosure provides telemetry-based device power consumption prediction. In the present disclosure, an ML model may be trained to determine the correlation between the device power consumption and the device telemetry. The trained ML model can then be utilized to predict the power consumed by a network device deployed in the field based on the device telemetry data. In many embodiments, the device telemetry data may be configured to indicate at least one of device performance and device physical condition.

The embodiments depicted in FIG. 1 may show the training environment 100 which includes a network device 102 (e.g., a device under test). The network device 102 may include hardware and/or software components that can facilitate data communication and transmission between computers or other network-enabled devices. In a network, the network device 102 plays an important role in establishing and maintaining connections. The network device manages and directs data traffic efficiently, ensuring seamless communication and collaboration within organizations and across the Internet. Examples of the network device 102 may include a router, a switch, a hub, a modem, an access point, a server, a computing node, or the like. The network device 102 may include a motherboard 104, a memory 106, a central processing unit (“CPU”) 108, and a power sourcing equipment (“PSE”) 110.

The motherboard 104 may serve as the central circuit board that houses and connects various essential components such as the CPU 108, the memory 106, storage devices, network interface cards, and other peripherals. The motherboard 104 may also provide interfaces for external connections, including ports for networking, audio, and video. Essentially, the motherboard 104 may serve as the foundation upon which the entire network device 102 operates, enabling data processing, storage, and communication tasks.

The memory 106 may include any suitable type of memory implemented using any suitable storage technology. For example, the memory 106 may comprise a Random Access Memory (“RAM”), a Nonvolatile Memory (“NVM”), or a combination of a RAM and an NVM. The memory 106 may include instructions to be performed by the CPU 108.

The CPU 108 can perform one or more operations by transitioning from one discrete, physical state to the next through the manipulation of switching elements that differentiate between and change these states. Switching elements may include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The PSE 110 may be configured to provide power to other devices over the network infrastructure. The most common application of PSE is PoE. PoE may be a technology that enables the transmission of electrical power alongside data over standard Ethernet cables.

At a high level, the ML model training may include data collection and development of the ML model. The purpose of data collection may be to collect multiple data points with information about the state of the network device 102 and its associated power consumption for training the ML model. In numerous additional embodiments, the ML model training may be executed in a lab setting. To enable the data collection and the ML model development, the training environment 100 may include a power source 112, a power sensor 114, environment sensors 116, a PoE tester 118, and a power manager 120.

The power source 112 may be configured to supply electrical energy to power the operation of the network device 102. The power sensor 114 may be coupled between the power source 112 and the network device 102. The power sensor 114 may include suitable circuitry that may be configured to perform one or more operations. For example, the power sensor 114 may be configured to measure downstream power going into the network device 102.

The environment sensors 116 may be coupled to the network device 102. The environment sensors 116 may include suitable circuitry that may be configured to perform one or more operations. For example, the environment sensors 116 may be configured to measure environmental conditions associated with the network device 102. In a number of embodiments, the environment sensors 116 may correspond to one or more temperature sensors configured to measure the temperature of the network device 102 as well as temperatures of various components of the network device 102 (e.g., a motherboard temperature, a CPU temperature, or the like). The scope of the present disclosure is not limited to environment sensors 116 corresponding to temperature sensors, and other types of sensors (such as humidity sensors) may be utilized additionally or alternatively.

The PoE tester 118 may be coupled to the network device 102. The PoE tester 118 may include suitable circuitry that may be configured to perform one or more operations. For example, the PoE tester 118 may be configured to draw varying loads through the PSE 110 and a PoE port of the network device 102. Further, the PoE tester 118 may be configured to measure the drawn power to determine the power consumption of the network device 102.

The power manager 120 may be coupled to the power sensor 114, the environment sensors 116, and the PoE tester 118. The power manager 120 may include suitable circuitry that may be configured to perform one or more operations. For example, the power manager 120 may be configured to read data measured by the power sensor 114, the environment sensors 116, and the PoE tester 118. The power manager 120 may be configured to execute one or more operations to train the ML model.

The power manager 120 may be configured to collect a base dataset associated with the network device 102. The base dataset may be collected based on the measurements read from the power sensor 114, the environment sensors 116, and the PoE tester 118. Various sensors may additionally be associated with the network device 102 and may enable the collection of the base dataset. The base dataset may include a plurality of values of power consumption and a set of telemetry parameters associated with the network device 102 collected over a time period. In some examples, the base dataset may include time-series data of the power consumption and the set of telemetry parameters associated with the network device 102.

In an example, the set of telemetry parameters may include at least one of a motherboard temperature, a CPU temperature, a PSE junction temperature, a total memory capacity, a free memory capacity, an available memory capacity, and a CPU idle percentage, associated with the network device 102. The motherboard temperature and the CPU temperature may correspond to the temperatures of the motherboard 104 and the CPU 108, respectively. The PSE junction temperature may correspond to the temperature at the junction where the PSE 110 couples to the external component (e.g., the PoE tester 118). The total memory capacity, the free memory capacity, and the available memory capacity may be values associated with the memory 106. The CPU idle percentage may be defined for each core of the CPU 108 and may indicate a time duration percentage for which the core is idle (e.g., is not actively executing any tasks).

The power manager 120 may be configured to facilitate one or more testing operations on the network device 102 for the collection of the base dataset. The one or more testing operations may be associated with variations in at least one of memory consumption, temperature, CPU load, and PoE draw associated with the network device 102. The base dataset may be collected based on the one or more testing operations. The one or more testing operations may be executed sequentially, and in each testing operation of the one or more testing operations, a set of values of the power consumption and the set of telemetry parameters may be collected. At least one of the set of values may be timestamped. In a variety of embodiments, each value of the set of values may be timestamped.

In more embodiments, the power manager 120 may be configured to execute, for example, a custom Python script (hereinafter “script”) to facilitate the one or more testing operations. In additional embodiments, a lab technician may initiate the execution of the script. In further embodiments, the script may include an identifier file containing hardware and software-specific information for the specification of the network device 102. This can allow the procedure to be generalized to other device specifications. The identifier file may indicate which components can be tested (e.g., sensors, CPU cores, PoE output, or the like) and the file paths used for reading sensor values. Thus, the script may determine whether the network device 102 is supported based on the identifier file and then facilitate execution of the one or more testing operations on the network device 102. Further, the script may collect various measurements associated with the network device 102, and output the measurements to comma-separated value (“CSV”) files. In still more embodiments, the script may enable the coupling of the power manager 120 to the network device 102 via a secure shell to control and read from the network device 102 remotely. Further, the script may control data collection using file paths provided by the identifier file, and read the measurements over universal asynchronous receiver-transmitter (“UART”) from the power sensor 114, the environment sensors 116, the PoE tester 118, or a combination thereof.

In an example, the one or more testing operations may include six testing operations (also referred to as “testing regimes”). However, the number of regimes may be different in other examples. The six testing regimes may include a PoE draw test, a memory test, a CPU cycle test, a CPU random test, a CPU maximum test, and a CPU idle test. In still further embodiments, each testing operation may be started immediately after the previous one is finished. In still additional embodiments, the one or more testing operations may be executed by running commands on the network device 102 using a tool, for example, the stress-ng tool. The tool may allow custom stressing of memory utilization and CPU load on each core of the CPU 108.

In the PoE draw test, PoE power can be drawn in 5 Watts (W) increments from OW to 30 W for each PoE output port. Each 5 W increment can be held for 75 seconds. This test may utilize the external PoE tester 118. In some more embodiments, the PoE tester 118 may operate in an automated manner. In yet more embodiments, the PoE tester 118 can be manually controlled by the lab technician. Each power measurement may be timestamped for later alignment.

In the memory test, the tool can be used to consume 25%, 50%, and 75% of the available memory, stressing the CPU 108. Each 25% increment can be held for 100 seconds. Each telemetry parameter measured during the memory test can be timestamped for later alignment.

In the CPU cycle test, each core of the CPU 108 may be loaded sequentially at 5% to 100% usage at 5% increments using the tool. In some examples, the CPU 108 may include four cores. Each setpoint may be held for 25 seconds. Further, each telemetry parameter measured during the CPU cycle test may be timestamped for later alignment.

In the CPU random test, all cores of the CPU 108 can be loaded using the tool to a random amount between 0% and 100% fifty times. Each setpoint can be held for 25 seconds. Further, each telemetry parameter measured during the CPU random test may be timestamped for later alignment.

In the CPU maximum test, all cores of the CPU 108 can be loaded using the tool to the maximum value. This setpoint can be held for 10 minutes. Further, each telemetry parameter measured during the CPU maximum test may be timestamped for later alignment.

In the CPU idle test, all cores of the CPU 108 can remain idle for 10 minutes. Further, each telemetry parameter measured during the CPU idle test can be timestamped for later alignment. The six testing regimes can thus facilitate the collection of data that can be utilized for the ML model training.

The data collection may be followed by ML model development. The ML model development may include data processing, feature engineering, model training and hyperparameter selection, and validation. As described above, the base dataset collected during the data collection phase may include the time-series data of the power consumption and the set of telemetry parameters associated with the network device 102. In an example, the base dataset may include a plurality of values of the power consumption, the motherboard temperature, the CPU temperature, the PSE junction temperature, the total memory capacity, the free memory capacity, the available memory capacity, and the CPU idle percentage, associated with the network device 102 collected over the time period. The values of the power consumption may be measured in milli-W (mW), the values of the motherboard, CPU, and PSE junction temperatures may be measured in milli-degree Celsius (m° C.), the total, free, and available memory capacity may be measured in bytes (B), and the CPU idle percentage may be a percentage value.

In the data processing phase, the power manager 120 may be configured to execute one or more processing operations on the base dataset. An example of a processing operation may include the identification and dropping of the outliers in the power measurements. In another example, in case of a slight time misalignment, a full join may be performed on the timestamp values and then missing values may be imputed using linear interpolation, except for temperature values where the imputation is performed with the last observed value. Dropping of transition periods between testing operations can be another example of a processing operation. Based on the execution of the one or more processing operations, the power manager 120 may be configured to generate a processed dataset.

In the feature engineering phase, the power manager 120 may be configured to generate one or more engineered parameters based on at least one of the set of telemetry parameters. For example, a total CPU non-idle percentage and a maximum CPU non-idle percentage may be generated based on the CPU idle percentage. In an example, the total CPU non-idle percentage may be generated using the expression (1):

$$400 - C P U 0 idle \% - C P U 1 idle \% - C P U 2 idle \% - C P U 3 idle \% \qquad ( 1 )$$

In an example, the maximum CPU non-idle percentage may be generated using the expression (2):

$$100 - minimum of ( C P U 0 idle \% , C P U 1 idle \% , C P U 2 idle \% , C P U 3 idle \% ) \qquad ( 2 )$$

where,
CPU0, CPU1, CPU2, and CPU3 may correspond to four cores of the CPU 108.

The engineered CPU parameters may be compared with the CPU non-idle percentage of each core of the CPU 108 in linear models to predict the power consumption for the whole time period (referred to as “Combined regime”) as well as for each testing regime individually. In an example, the first model can be shown below in equation (3):

$$E [ power ] = a 0 + ( a 1 * C P U 0 non - idle \% ) + ( a 2 * C P U 1 non - idle \% ) + ( a 3 * C P U 2 non - idle \% ) + ( a 4 * C P U 3 non - idle \% ) \qquad ( 3 )$$

In an example, the second model can be shown below in equation (4):

$$E [ power ] = b 0 + ( b 1 * total C P U non - idle \% ) + ( b 2 * maximum C P U non - idle \% ) \qquad ( 4 )$$

For each model and testing regime, Akaiki Information Criteria (“AIC”) and adjusted R squared (“aR2”) may be calculated. Both are measures that reward model fit and penalize complexity, where a lower AIC and a higher aR2 may be preferred. In some examples, the second model may be preferred to the first model for the Combined, the CPU cycle test, CPU random test, and the CPU idle testing regimes, whereas the first model may be preferred to the second model for the POE draw and memory testing regimes. The two models may be neutral for the CPU max testing regime because there is little variation in the CPU usage for that regime.

In the model training and hyperparameter selection phase, the power manager 120 may be configured to select a set of model parameters for model development. In still yet more embodiments, the set of model parameters may include the one or more engineered parameters and a subset of telemetry parameters of the set of telemetry parameters. In an example, the set of model parameters may include the motherboard temperature, the CPU temperature, the PSE junction temperature, the free memory capacity, the total CPU non-idle percentage, and the maximum CPU non-idle percentage, associated with the network device 102.

The power manager 120 may be configured to determine a training dataset and a test dataset from the base dataset (e.g., the processed dataset). The training dataset may be utilized to train the ML model, whereas the test dataset may be utilized to validate the trained ML model. The training dataset may thus include one or more values of the power consumption and the set of model parameters associated with the network device 102 collected over the time period. For example, the training dataset may include one or more values, collected over the time period, of the power consumption associated with the network device 102, and at least one of the motherboard temperature, the CPU temperature, the PSE junction temperature, the free memory capacity, the total CPU non-idle percentage, and the maximum CPU non-idle percentage associated with the network device 102. In other words, the training dataset may include exclusively the telemetry parameters that are selected for the model development. Similarly, the test dataset may include one or more values of the power consumption and the set of model parameters associated with the network device 102 collected over the time period. The training and test datasets can thus be subsets of the processed dataset.

The power manager 120 may be configured to train an ML model based on the training dataset. In many further embodiments, the ML model may be trained using a supervised machine learning algorithm that trains a linear regression with elastic net regularization using cross-validation and parameters for the motherboard temperature, the CPU temperature, the PSE junction temperature, the free memory capacity, the total CPU non-idle percentage, and the maximum CPU non-idle percentage on the response power measurement. In an example, the general form of the model can be shown below in equation (5):

$${min}_{{β}_{0} , β} \frac{1}{N} {\sum }_{i = 1}^{N} {( {y}_{i} - {β}_{0} - ( {β}^{T} * {x}_{i} ) )}^{2} + λ * [ ( \frac{1}{2} * ( 1 - α ) {‖ β ‖}_{2}^{2} ) + α {‖ β ‖}_{1} ] \qquad ( 5 )$$

where,
i=observation number,
N=total number of observations,
yᵢ=power,
β₀=intercept or bias,
β=weight or coefficient vector,
xᵢ=feature vector,
λ=overall penalty strength, and
α=elastic net penalty.

A grid of 100 different value pairs for the Cartesian product of elastic net hyperparameters α=[0.1, 0.2, 0.3, 0.4, 0.5, 0.6, 0.7, 0.8, 0.9, 1.0] and λ=[1.69, 3.89, 9, 20.79, 48.02, 110.93, 256.25, 591.98, 1367.55, 3159.21] may be considered. For each hyperparameter pair, the minimization over β₀ and β may be performed with cyclical coordinate descent. The optimal model hyperparameters can be chosen by minimum root mean square error (“RMSE”) on hold-out sets from 5-fold cross-validation within the training data. For example, the training dataset may be divided into five folds, and for each iteration, four folds can be used for training and one fold can be used for validation. Thus, across the iterations, each fold may be used for training as well as validation. In an example, the optimal parameters may be α=1.0 and λ=1.69. The model can then be re-trained to the entire training dataset using the optimal hyperparameters.

An example of the final supervised ML model can be shown below in equation (6):

$$Predicted power = - 79439 7.9 + ( 7.269 \; 021 e - 03 * C T ) + ( 1.985 \; 157 e + 01 * P T ) + ( 8.705 \; 677 e + 01 * S N I ) + ( 2.642 \; 198 e + 03 * M N I ) + ( 2.421 \; 821 e - 04 * M T * C T ) + ( 2.016 \; 051 e - 04 * M T * P T ) - ( 7.380389 e - 10 * M T * F M ) - ( 1.33379 e - 03 * M T * S N I ) - ( 1.853332 e - 02 * M T * M N I ) + ( 1.420 \; 354 e - 04 * C T * P T ) - ( 5.348927 e - 04 * C T * S N I ) - ( 1.498916 e - 02 * C T * M N I ) + ( 2.3207 e - 09 * P T * F M ) + ( 5.827 \; 178 e - 02 * P T * M N I ) - ( 1.439187 e - 06 * F M * S N I ) + ( 7.864 \; 122 e - 06 * F M * M N I ) - ( 1.541788 e - 01 * S N I * M N I ) \qquad ( 6 )$$

where,
MT=the motherboard temperature,
CT=the CPU temperature,
PT=the PSE junction temperature,
FM=the free memory capacity,
SNI=the total CPU non-idle percentage, and
MNI=the maximum CPU non-idle percentage.

The ML model can thus be trained for device power consumption prediction. In other words, the trained ML model may be configured to predict device power consumption based on device telemetry data. The device telemetry data may include the motherboard temperature, the CPU temperature, the PSE junction temperature, the free memory capacity, the total CPU non-idle percentage, and the maximum CPU non-idle percentage. Thus, the device telemetry data may correspond to hardware telemetry data.

The trained ML model may require validation prior to being implemented in the field. In the validation phase, the power manager 120 may be configured to validate the trained ML model based on the test dataset. For example, the power manager 120 may be configured to predict power consumed by the network device 102 based on a set of telemetry values derived from the test dataset. In an example, the set of telemetry values may include values of the motherboard temperature, the CPU temperature, the PSE junction temperature, the free memory capacity, the total CPU non-idle percentage, and the maximum CPU non-idle percentage. The trained ML model may be validated based on the predicted power and a power consumption value of the test dataset. For example, the trained ML model may be validated based on a comparison of the predicted power and the power consumption value of the test dataset. Based on the validation of the trained ML model, the power manager 120 may be configured to determine an error associated with the trained ML model. In many additional embodiments, the error may correspond to mean absolute percentage error (“MAPE”). The aforementioned operations may be performed for each testing regime as well as for the combined regime.

If the error for all regimes is less than or equal to a threshold value, the ML model may be considered fit for use in the field. In some examples, the threshold value may correspond to 10%. However, other threshold values may also be possible. If the error for one or more testing regimes is greater than the threshold value (e.g., the error is not acceptable), the ML model may require tuning. In still yet further embodiments, the power manager 120 may be configured to tune the ML model based on the determined error. The tuning of the ML model may include collecting a base dataset, selecting model parameters based on the base dataset, and re-training the ML model based on the model parameters. The re-trained ML model may further be re-validated. The tuning may lead to a change in the determined error in subsequent iterations. The tuning may be executed until the error is less than or equal to the threshold value (e.g., the error is acceptable).

The power manager 120 may thus obtain the trained ML model for device power consumption prediction. To enable the abovementioned operations, the power manager 120 may include various engines, such as a data collector 122, a data processor 124, a feature selector 126, an ML engine 128, a validator 130, and a tuner 132. Each of the aforementioned engines may be implemented by way of hardware, software, firmware, or a combination of these such that each engine includes a processing logic that when executed performs a specific task for training an ML model 134.

The data collector 122 may be coupled to the power sensor 114, the environment sensors 116, and the PoE tester 118. The data collector 122 may be configured to collect the base dataset associated with the network device 102. In an example, the data collector 122 may be configured to facilitate the one or more testing operations on the network device 102 for the collection of the base dataset. In still yet additional embodiments, the data collector 122 may be implemented as a Raspberry Pi engine.

The data processor 124 may be configured to execute one or more processing operations on the base dataset. Based on the execution of the one or more processing operations, the data processor 124 may be configured to generate a processed dataset. The processed dataset may then be utilized for training the ML model 134.

The feature selector 126 may be configured to generate the one or more engineered parameters based on at least one of the set of telemetry parameters. The feature selector 126 may be configured to select the set of model parameters for model development. The set of model parameters may include the one or more engineered parameters and the subset of telemetry parameters of the set of telemetry parameters.

The ML engine 128 may be configured to determine the training dataset and the test dataset from the base dataset (e.g., the processed dataset). The ML engine 128 may be configured to train the ML model 134 based on the training dataset. The trained ML model 134 may be configured to predict device power consumption based on the device telemetry data. The device telemetry data may include the motherboard temperature, the CPU temperature, the PSE junction temperature, the free memory capacity, the total CPU non-idle percentage, and the maximum CPU non-idle percentage associated with a network device.

The validator 130 may be configured to validate the trained ML model 134 based on the test dataset. For example, the validator 130 may be configured to predict, using the trained ML model 134, power consumed by the network device 102 based on the set of telemetry values derived from the test dataset. The set of telemetry values may include values of the motherboard temperature, the CPU temperature, the PSE junction temperature, the free memory capacity, the total CPU non-idle percentage, and the maximum CPU non-idle percentage, associated with the network device 102. The trained ML model 134 may be validated based on the predicted power and the power consumption value of the test dataset.

The tuner 132 may be configured to determine an error associated with the trained ML model 134 based on the validation of the trained ML model 134. If the error for one or more testing regimes is greater than the threshold value (e.g., the error is not acceptable), the ML model 134 may require tuning. The tuner 132 may be configured to tune the ML model 134 based on the determined error. The tuning of the ML model may include collecting a base dataset, selecting model parameters based on the base dataset, and re-training the ML model based on the model parameters. The re-trained ML model may further be re-validated. The tuning may be executed until the error is less than or equal to the threshold value (e.g., the error is acceptable).

In several embodiments, a trained ML model may be extrapolated to predict the power consumption of devices deployed in the field and the power prediction error may be determined. Such errors can be utilized to validate and tune the trained ML model. The ML model of the present disclosure describes an additive relationship between the power and the telemetry parameters. In several more embodiments, a multiplicative model can be considered by log transforming the variables.

The scope of the present disclosure is not limited to the utilization of a fully interacted linear model. Other models (such as tree-based models, artificial neural networks, or the like) may also be utilized. Further, the scope of the present disclosure is not limited to executing the six testing regimes described above. Alternate or additional testing regimes may also be utilized.

In numerous embodiments, the ML model validation can also be executed in the field. This methodology can be applied to devices with onboard power sensors. The predicted power consumption can be compared to the reported power consumption to determine the accuracy of the predictions. Such measurements from the devices with power sensors can be used to continually improve the ML model for devices without power sensors.

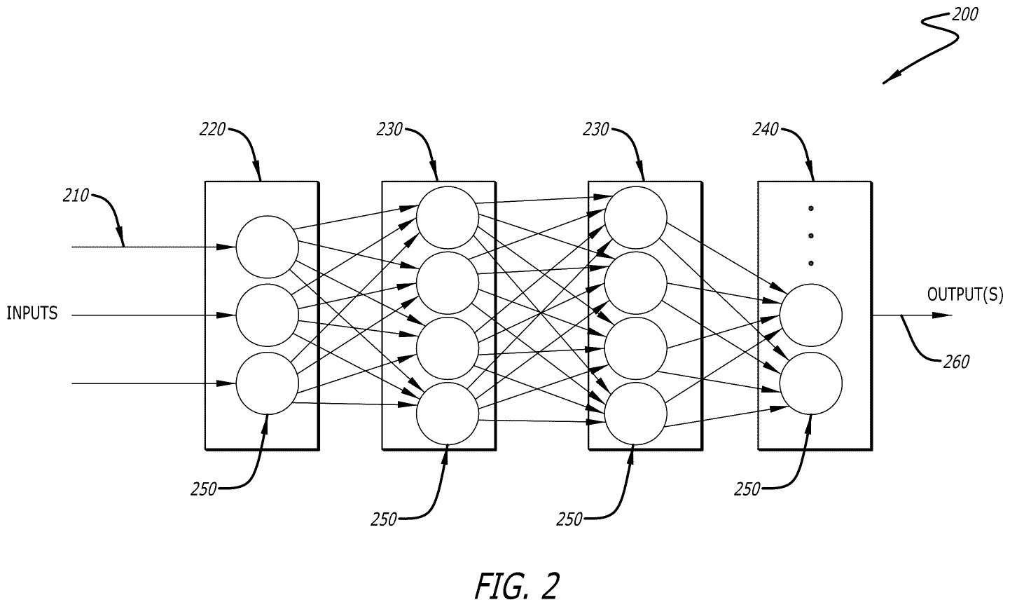

Although a specific embodiment for a training environment 100 suitable for carrying out the various steps, processes, methods, and operations described herein is discussed with respect to FIG. 1, any of a variety of systems and/or processes may be utilized in accordance with embodiments of the disclosure. For example, additional telemetry parameters (such as fan speed) may also be utilized for the model training. Conversely, the ML model may be trained based on only a few of the abovementioned list of parameters. The elements depicted in FIG. 1 may also be interchangeable with other elements of FIGS. 2-8 as required to realize a particularly desired embodiment.

Referring to FIG. 2, a conceptual illustration of an ML model 200 in accordance with various embodiments of the disclosure is shown. ML models have increased in popularity, especially in deep learning techniques where the detection of complex patterns in data and the ability to solve a wide range of problems has been desired. As those skilled in the art will recognize, various methods of ML models can be utilized to achieve desired outcomes efficiently. For example, some embodiments may utilize decision trees, random forests, support vector machines, naïve Bayes, K-nearest neighbors' algorithms, artificial neural networks, or the like. The ML model 200 may include three main types of layers: the input layer, the output layer, and one or more intermediate (also called hidden) layers.

In many embodiments, the input layer is responsible for receiving input data, which could be anything from an image to a text document to numerical values. In the present disclosure, the input data can be device hardware telemetry data. The device hardware telemetry data may include a motherboard temperature, a CPU temperature, a PSE junction temperature, a free memory capacity, a total CPU non-idle percentage, and a maximum CPU non-idle percentage, associated with a network device. Each input feature can be represented by a node in the input layer. Conversely, the output layer is often responsible for producing the output of the network, which could be, for example, a prediction or a classification. In the present disclosure, the output may be predicted device power consumption. The number of nodes in the output layer can depend on the task at hand. For example, if the task is to classify images into ten different categories, there would be ten nodes in the output layer, each representing a different category.

The intermediate layers are where the specialized connections can be made. These intermediate layers may be responsible for transforming the input data in a non-linear way to extract meaningful features that can be used for the final output. In various embodiments, a node in an intermediate layer can take as an input a weighted sum of the outputs from the previous layer, apply a non-linear activation function to it, and pass the result on to the next layer. The weights of the connections between nodes in the layers can be learned during training. This training can utilize backpropagation, which may involve calculating the gradient of the error with respect to the weights and adjusting the weights accordingly to minimize the error.

At a high level, the ML model 200 depicted in the embodiment of FIG. 2 can include a number of inputs 210, an input layer 220, one or more intermediate layers 230, and an output layer 240. The ML model 200 may comprise a collection of connected units or nodes called artificial neurons 250, which may loosely model the neurons in a biological brain. Each connection, like the synapses in a biological brain, can transmit a signal from one artificial neuron to another. An artificial neuron that receives a signal can process the signal and then trigger additional artificial neurons within the next layer of the neural network. As those skilled in the art will recognize, the ML model 200 depicted in FIG. 2 is shown as an illustrative example, and various embodiments may comprise artificial neural networks that can accept more than one type of input and can provide more than one type of output.

In some embodiments, the signal at a connection between artificial neurons may be a value, and the output of each artificial neuron may be computed by some nonlinear function (called an activation function) of the sum of the artificial neuron's inputs. Often, the connections between artificial neurons are called “edges” or axons. Artificial neurons and edges typically have a weight that adjusts as learning proceeds. The weight increases or decreases the strength of the signal at a connection. Artificial neurons may have a threshold (trigger threshold) such that the signal is only sent if the aggregate signal crosses that threshold. Typically, artificial neurons may be aggregated into layers. Different layers may perform different kinds of transformations on their inputs. Signals propagate from the first layer (the input layer 220) to the last layer (the output layer 240), possibly after traversing one or more intermediate layers (also called hidden layers) 230.

The inputs to an ML model may vary depending on the problem being addressed. In one embodiment, the ML model 200 may include a series of hidden layers in which each neuron is fully connected to neurons of the next layer. The ML model 200 may utilize an activation function such as sigmoid, nonlinear, or a rectified linear unit, upon the sum of the weighted inputs, for example. The last layer in the ML model 200 may implement a regression function to produce the classifications or predictions as output 260. In further embodiments, a sigmoid function can be used, and the prediction may need raw output transformation into linear and/or nonlinear data.

In numerous additional embodiments, the ML model 200 may be sans the one or more intermediate layers 230. In such a scenario, signals may propagate from the first layer (the input layer 220) directly to the last layer (the output layer 240). The ML model 200 may determine a correlation between the inputs to predict an output. For example, the ML model 200 may determine a correlation between device hardware telemetry data to predict device power consumption.

Although a specific embodiment for an ML model suitable for carrying out the various steps, processes, methods, and operations described herein is discussed with respect to FIG. 2, any of a variety of systems and/or processes may be utilized in accordance with embodiments of the disclosure. For example, an ML model may be externally operated, such as through a cloud-based service or a third-party service. The elements depicted in FIG. 2 may also be interchangeable with other elements of FIGS. 1 and 3-8 as required to realize a particularly desired embodiment.

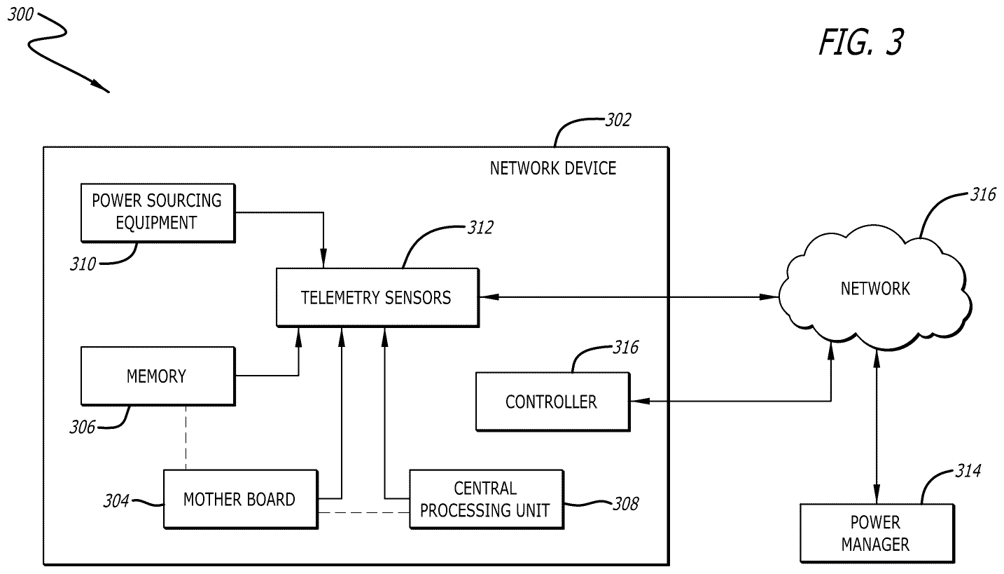

Referring to FIG. 3, a schematic block diagram of an example environment 300 for off-device power prediction in accordance with various embodiments of the disclosure is shown. The embodiments depicted in FIG. 3 may show the environment 300 which includes a network device 302. The network device 302 may include hardware and/or software components that facilitate communication and transmission of data between computers or other network-enabled devices. Examples of the network device 302 may include a router, a switch, a hub, a modem, an access point, a server, a computing node, or the like.

Given the critical role network devices play in wireless networks, it is important to monitor the health of the network devices (such as the network device 302) regularly. Moreover, as organizations increasingly prioritize environmental sustainability, it is beneficial to manage the carbon footprint of network devices. The amount of power a device consumes serves as an indicator of its health and carbon footprint. Thus, accurately measuring this power consumption of network devices can be leveraged for both monitoring device health and controlling its environmental impact.

Conventionally, external or internal power sensors can be utilized to monitor power consumption in network devices. However, these sensors come with drawbacks such as being costly, bulky, and intricate to develop. Consequently, outfitting all network devices with such sensors may not be always practical. While PSUs with integrated power monitoring offer a solution, they can be expensive and not suitable for smaller devices like access points and cameras, which lack a dedicated PSU. Although external power monitors find utility in lab settings to gauge power consumption limits, their broad ranges and inability to provide real-time data may hinder their effectiveness. Therefore, extrapolating lab power consumption measurements to field devices may introduce biases due to these dependencies.

To overcome the aforementioned issues with power measurement, the present disclosure provides telemetry-based device power consumption prediction. In the present disclosure, an ML model may be trained based on values of various telemetry parameters of network devices to determine the correlation between the device power consumption and the device telemetry. The trained ML model can then be utilized to predict the power consumed by the network device 302 deployed in the field based on the telemetry data of the network device 302. In many embodiments, the telemetry data may be configured to indicate at least one of the performance and physical condition of the network device 302.

The network device 302 may include a motherboard 304, a memory 306, a CPU 308, and a PSE 310. The motherboard 304 may serve as the central circuit board that houses and connects various essential components such as the CPU 308, the memory 306, storage devices, network interface cards, and other peripherals. The memory 306 may include any suitable type of memory implemented using any suitable storage technology. The memory 306 may include instructions to be performed by the CPU 308. The CPU 308 can perform one or more operations by transitioning from one discrete, physical state to the next through the manipulation of switching elements that differentiate between and change these states. The PSE 310 may be configured to provide power to other devices over the network infrastructure.

The network device 302 may further include telemetry sensors 312. The telemetry sensors 312 may be coupled to the motherboard 304, the memory 306, the CPU 308, and the PSE 310. The telemetry sensors 312 may be configured to sense various telemetry parameters associated with the network device 302 and generate device telemetry data based on the sensed parameters. In a number of embodiments, the device telemetry data may include a plurality of values of at least one of a motherboard temperature, a CPU temperature, a PSE junction temperature, a total memory capacity, a free memory capacity, an available memory capacity, and a CPU idle percentage, associated with the network device 302. Each value may be timestamped. The motherboard temperature and the CPU temperature may correspond to the temperatures of the motherboard 304 and the CPU 308, respectively. The PSE junction temperature may correspond to the temperature at the junction where the PSE 310 couples to an external component (e.g., a PoE draw device). The total memory capacity, the free memory capacity, and the available memory capacity may be values associated with the memory 306. The CPU idle percentage may be defined for each core of the CPU 308 and may indicate a time duration percentage for which the core is idle (e.g., is not actively executing any tasks).

The network device 302 may be coupled to a power manager 314 by way of a network 316. In a variety of embodiments, the power manager 314 may be implemented in another network device, a cloud-based device, or the like. Examples of the network 316 may include, but are not limited to, a wireless fidelity network, a light fidelity network, a local area network, a wide area network, a metropolitan area network, a satellite network, the Internet, a fiber optic network, a coaxial cable network, an infrared network, a radio frequency network, or a combination thereof. The network device 302 (e.g., the telemetry sensors 312) may be configured to provide the device telemetry data to the power manager 314 by way of the network 316.

The power manager 314 may thus be configured to receive the device telemetry data. Based on the device telemetry data, the power manager 314 may be configured to determine a set of values of one or more telemetry parameters. The one or more telemetry parameters may include at least one of the motherboard temperature, the CPU temperature, the PSE junction temperature, the free memory capacity, a total CPU non-idle percentage, and a maximum CPU non-idle percentage, associated with the network device 302. The total CPU non-idle percentage and the maximum CPU non-idle percentage may be generated based on the CPU idle percentage included in the device telemetry data. The one or more telemetry parameters may thus correspond to model parameters that are utilized for training the ML model.

The power manager 314 may be configured to provide the set of values as an input to a trained ML model. The ML model may be trained to determine the correlation between the device power consumption and the device telemetry. Thus, the power manager 314 may be configured to predict the power consumption of the network device 302 based on an output of the trained ML model for the set of values. In more embodiments, the power consumption may be predicted in real time. In additional embodiments, the power manager 314 may be configured to buffer the device telemetry data and predict the power consumption of the network device 302 for a historical time instance using the buffered device telemetry data. In further embodiments, since changes in power can cause a change in temperature (in temporal order), power predictions can be improved by using future temperature measurements.

The power manager 314 may be configured to determine whether the predicted power is within a desired power range. If the power manager 314 determines that the predicted power is outside the desired power range, the power manager 314 may be configured to generate a trigger signal. The trigger signal may be configured to indicate that the power consumption of the network device 302 is outside the desired power range. The power manager 314 may be configured to provide the trigger signal to the network device 302 via the network 316.

The network device 302 may further include a controller 318. The controller 318 may include suitable circuitry that may be configured to perform one or more operations. For example, the controller 318 may be configured to receive the trigger signal and control one or more device features of the network device 302 based on the trigger signal. Thus, the one or more device features can be controlled based on the predicted device power consumption. In still more embodiments, the controlling of a device feature may correspond to the activation of the device feature. In still further embodiments, the controlling of a device feature may correspond to the deactivation of the device feature. In still additional embodiments, the controlling of a device feature may correspond to altering the intensity of the device feature. The device features may correspond to various hardware and software features (e.g., access ports, interfaces, communication protocols, blinking lights, switching mechanisms, security techniques, quality of service, or the like).

Thus, in the present disclosure, telemetry data of a network device can be utilized for predicting the power consumed by the network device. The present disclosure thus provides a solution that can enable power consumption prediction without adding power sensors to the network devices. Consequently, the cost and size of the network devices can be reduced. Further, network devices having a simpler design with fewer components can be developed.

Although a specific embodiment for off-device power prediction for carrying out the various steps, processes, methods, and operations described herein is discussed with respect to FIG. 3, any of a variety of systems and/or processes may be utilized in accordance with embodiments of the disclosure. For example, a “time since last report” feature can be included with the device telemetry data to enable accurate prediction. The elements depicted in FIG. 3 may also be interchangeable with other elements of FIGS. 1, 2, and 4-8 as required to realize a particularly desired embodiment.

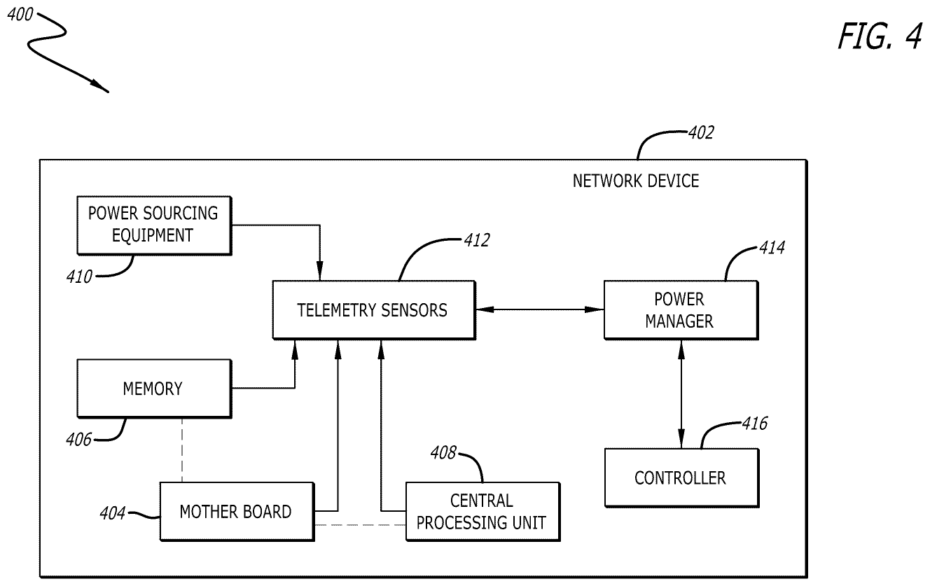

Referring to FIG. 4, a schematic block diagram of a network device 402 in accordance with various embodiments of the disclosure is shown. The network device 402 may include hardware and/or software components that facilitate communication and transmission of data between computers or other network-enabled devices. Examples of the network device 402 may include a router, a switch, a hub, a modem, an access point, a server, a computing node, or the like.

Given the critical role network devices play in wireless networks, it is important to regularly monitor their health. Additionally, as organizations prioritize environmental sustainability, managing the carbon footprint of these devices is beneficial. Power consumption serves as an indicator of both device health and carbon footprint. Thus, accurately measuring this power consumption can be leveraged for both monitoring device health and controlling its environmental impact.

Conventionally, power consumption may be monitored using external or internal sensors. However, these sensors can be costly, bulky, and complex, making it impractical to equip all devices with them. While PSUs with integrated monitoring are a solution, they can be expensive and unsuitable for smaller devices like access points and cameras, which lack dedicated PSUs. External monitors, used in lab settings, have broad ranges and cannot provide real-time data, making them less effective. Extrapolating lab measurements to field devices can introduce biases due to these limitations.

To overcome the aforementioned issues with power measurement, the present disclosure provides telemetry-based device power consumption prediction. In the present disclosure, an ML model may be trained based on values of various telemetry parameters of network devices to determine the correlation between the device power consumption and the device telemetry. The trained ML model can then be utilized to predict the power consumed by the network device 402 deployed in the field based on the telemetry data of the network device 402. In many embodiments, the telemetry data may be configured to indicate at least one of performance and physical condition of the network device 402.

The network device 402 may include a motherboard 404, a memory 406, a CPU 408, and a PSE 410. The motherboard 404 can serve as the central circuit board that houses and connects various essential components such as the CPU 408, the memory 406, storage devices, network interface cards, and other peripherals. The memory 406 may include any suitable type of memory implemented using any suitable storage technology. The memory 406 may include instructions to be performed by the CPU 408. The CPU 408 can perform one or more operations by transitioning from one discrete, physical state to the next through the manipulation of switching elements that differentiate between and change these states. The PSE 410 may be configured to provide power to other devices over the network infrastructure.

The network device 402 may further include telemetry sensors 412. The telemetry sensors 412 may be coupled to the motherboard 404, the memory 406, the CPU 408, and the PSE 410. The telemetry sensors 412 may be configured to sense various telemetry parameters associated with the network device 402 and generate device telemetry data based on the sensed parameters. In a number of embodiments, the device telemetry data may include a plurality of values of at least one of a motherboard temperature, a CPU temperature, a PSE junction temperature, a total memory capacity, a free memory capacity, an available memory capacity, and a CPU idle percentage, associated with the network device 402. Each value may be timestamped. The motherboard temperature and the CPU temperature may correspond to the temperatures of the motherboard 404 and the CPU 408, respectively. The PSE junction temperature may correspond to the temperature at the junction where the PSE 410 couples to an external component (e.g., a PoE draw device). The total memory capacity, the free memory capacity, and the available memory capacity may be values associated with the memory 406. The CPU idle percentage may be defined for each core of the CPU 408 and may indicate a time duration percentage for which the core is idle (e.g., is not actively executing any tasks).

The network device 402 may further include a power manager 414 that may be configured to receive the device telemetry data from the telemetry sensors 412. Based on the device telemetry data, the power manager 414 may be configured to determine a set of values of one or more telemetry parameters. The one or more telemetry parameters may include at least one of the motherboard temperature, the CPU temperature, the PSE junction temperature, the free memory capacity, a total CPU non-idle percentage, and a maximum CPU non-idle percentage, associated with the network device 402. The total CPU non-idle percentage and the maximum CPU non-idle percentage may be generated based on the CPU idle percentage included in the device telemetry data. The one or more telemetry parameters may thus correspond to model parameters that are utilized for training the ML model.

The power manager 414 may be configured to provide the set of values as an input to a trained ML model. The ML model may be trained to determine the correlation between the device power consumption and the device telemetry. Thus, the power manager 414 may be configured to predict the power consumption of the network device 402 based on an output of the trained ML model for the set of values.

The power manager 414 may be configured to determine whether the predicted power is within a desired power range. If the power manager 414 determines that the predicted power is outside the desired power range, the power manager 414 may be configured to generate a trigger signal. The trigger signal may be configured to indicate that the power consumption of the network device 402 is outside the desired power range.

The network device 402 may further include a controller 416. The controller 416 may include suitable circuitry that may be configured to perform one or more operations. For example, the controller 416 may be configured to receive the trigger signal from the power manager 414 and control one or more device features of the network device 402 based on the trigger signal. In still more embodiments, the controlling of a device feature may correspond to the activation of the device feature. In still further embodiments, the controlling of a device feature may correspond to the deactivation of the device feature. In still additional embodiments, the controlling of a device feature may correspond to altering the intensity of the device feature. The device features may correspond to various hardware and software features (e.g., access ports, interfaces, communication protocols, blinking lights, switching mechanisms, security techniques, quality of service, or the like).

Although a specific embodiment for a network device 402 for carrying out the various steps, processes, methods, and operations described herein is discussed with respect to FIG. 4, any of a variety of systems and/or processes may be utilized in accordance with embodiments of the disclosure. For example, power prediction in other types of devices that generate telemetry data may be executed in a similar manner. The elements depicted in FIG. 4 may also be interchangeable with other elements of FIGS. 1-3 and 5-8 as required to realize a particularly desired embodiment.

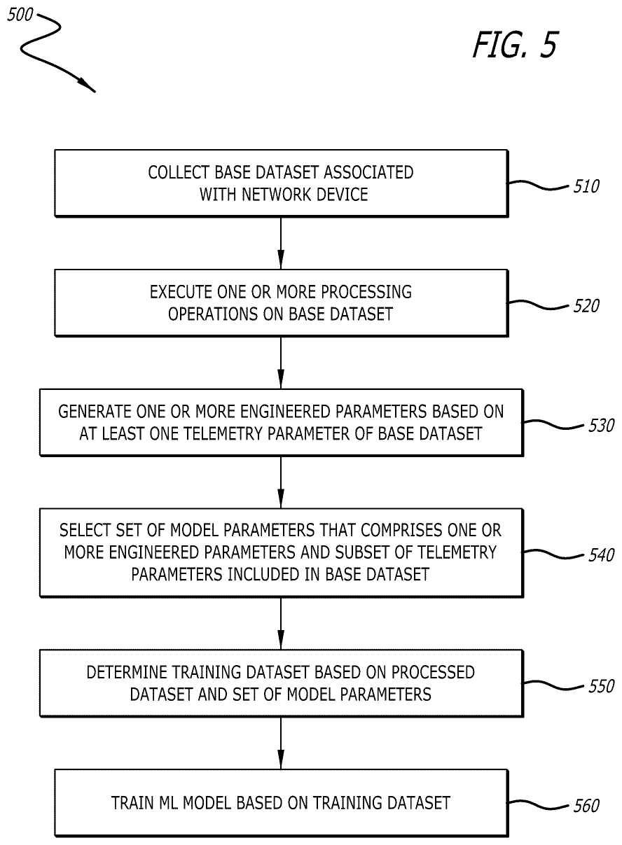

Referring to FIG. 5, a process 500 for training an ML model for power consumption prediction in accordance with various embodiments of the disclosure is shown. In many embodiments, the process 500 may collect a base dataset associated with a network device (block 510). The base dataset may include a plurality of values of power consumption and a set of telemetry parameters associated with the network device collected over a time period. The set of telemetry parameters may include at least one of a motherboard temperature, a CPU temperature, a PSE junction temperature, a total memory capacity, a free memory capacity, an available memory capacity, and a CPU idle percentage, associated with the network device. The base dataset may be collected based on the one or more testing operations. The one or more testing operations may be associated with variations in at least one of memory consumption, temperature, CPU load, and PoE draw associated with the network device. The one or more testing operations may be executed sequentially, and in each testing operation of the one or more testing operations, a set of values of the power consumption and the set of telemetry parameters can be collected. At least one of the set of values may be timestamped.

In a number of embodiments, the process 500 may execute one or more processing operations on the base dataset (block 520). An example of a processing operation may include the identification and dropping of the outliers in the power measurements. In another example, in case of a slight time misalignment, a full join may be performed on the timestamp values and then missing values may be imputed using linear interpolation, except for temperature values where the imputation is performed with the last observed value. Dropping of transition periods between testing operations can be another example of a processing operation. Based on the execution of the one or more processing operations, a processed dataset may be generated.

In a variety of embodiments, the process 500 may generate one or more engineered parameters based on at least one telemetry parameter of the base dataset (block 530). For example, a total CPU non-idle percentage and a maximum CPU non-idle percentage may be generated based on the CPU idle percentage. The total CPU non-idle percentage may be generated by subtracting a sum of CPU idle percentages of all CPU cores from 100*a number of cores. The maximum CPU non-idle percentage may be generated by subtracting the least CPU idle percentage among all cores from 100.

In more embodiments, the process 500 may select a set of model parameters that comprises the one or more engineered parameters and a subset of telemetry parameters included in the base dataset (block 540). Thus, the set of model parameters may include the one or more engineered parameters and a subset of the set of telemetry parameters. In an example, the set of model parameters may include the motherboard temperature, the CPU temperature, the PSE junction temperature, the free memory capacity, the total CPU non-idle percentage, and the maximum CPU non-idle percentage, associated with the network device.

In additional embodiments, the process 500 may determine a training dataset based on the processed dataset and the set of model parameters (block 550). The training dataset may thus include one or more values of the power consumption and the set of model parameters associated with the network device collected over the time period. For example, the training dataset may include one or more values, collected over the time period, of the power consumption, the motherboard temperature, the CPU temperature, the PSE junction temperature, the free memory capacity, the total CPU non-idle percentage, and the maximum CPU non-idle percentage associated with the network device. In other words, the training dataset may include exclusively the telemetry parameters that are selected for the model development.

In further embodiments, the process 500 may train the ML model based on the training dataset (block 560). In many further embodiments, the ML model may be trained using a supervised machine learning algorithm that trains a linear regression with elastic net regularization using cross-validation and parameters for the motherboard temperature, the CPU temperature, the PSE junction temperature, the free memory capacity, the total CPU non-idle percentage, and the maximum CPU non-idle percentage on the response power measurement. The ML model can thus be trained for device power consumption prediction. The trained ML model may be configured to predict device power consumption based on device telemetry data. The device telemetry data may include the values of the motherboard temperature, the CPU temperature, the PSE junction temperature, the free memory capacity, the total CPU non-idle percentage, and the maximum CPU non-idle percentage.

Although a specific embodiment for training an ML model for power consumption prediction for carrying out the various steps, processes, methods, and operations described herein is discussed with respect to FIG. 5, any of a variety of systems and/or processes may be utilized in accordance with embodiments of the disclosure. For example, additional telemetry parameters (such as fan speed) may also be utilized for the model training. The elements depicted in FIG. 5 may also be interchangeable with other elements of FIGS. 1-4 and 6-8 as required to realize a particularly desired embodiment.

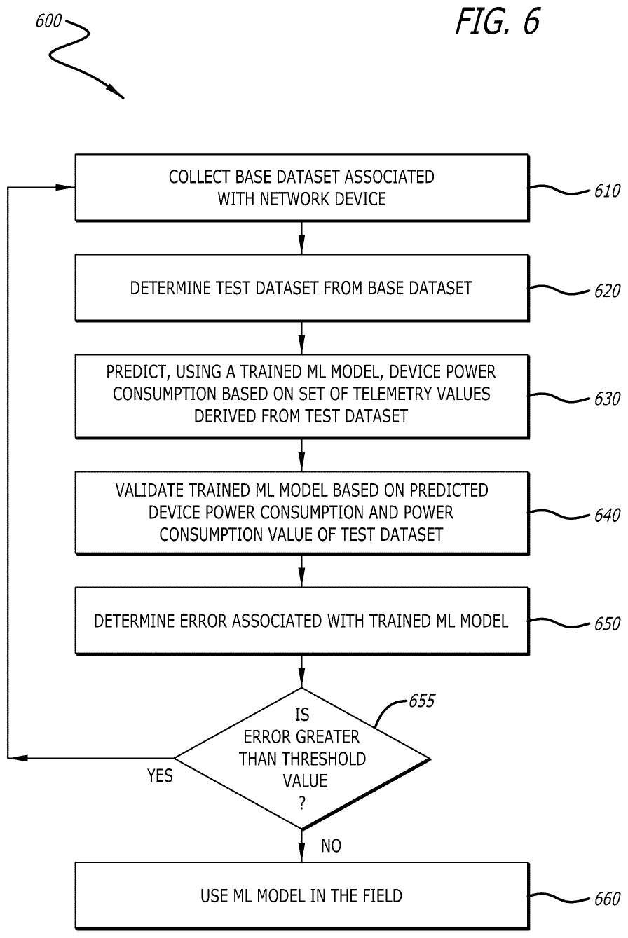

Referring to FIG. 6, a process 600 for validating an ML model trained for power consumption prediction in accordance with various embodiments of the disclosure is shown. In many embodiments, the process 600 may collect a base dataset associated with a network device (block 610). The base dataset may include a plurality of values of power consumption and a set of telemetry parameters associated with the network device collected over a time period. The set of telemetry parameters may include at least one of a motherboard temperature, a CPU temperature, a PSE junction temperature, a total memory capacity, a free memory capacity, an available memory capacity, and a CPU idle percentage, associated with the network device.

In a number of embodiments, the process 600 may determine a test dataset from the base dataset (block 620). The test dataset may include one or more values of the power consumption and a set of model parameters associated with the network device collected over the time period. In an example, the set of model parameters may include the motherboard temperature, the CPU temperature, the PSE junction temperature, the free memory capacity, a total CPU non-idle percentage, and a maximum CPU non-idle percentage associated with the network device. The total CPU non-idle percentage may be generated by subtracting a sum of CPU idle percentages of all CPU cores from 100*a number of cores. The maximum CPU non-idle percentage may be generated by subtracting the least CPU idle percentage among all cores from 100. Thus, the test dataset may include one or more values, collected over the time period, of the power consumption, the motherboard temperature, the CPU temperature, the PSE junction temperature, the free memory capacity, the total CPU non-idle percentage, and the maximum CPU non-idle percentage associated with the network device.

In a variety of embodiments, the process 600 may predict, using a trained ML model, device power consumption based on a set of telemetry values derived from the test dataset (block 630). The set of telemetry values may include values of the motherboard temperature, the CPU temperature, the PSE junction temperature, the free memory capacity, the total CPU non-idle percentage, and the maximum CPU non-idle percentage. In other words, the set of telemetry values may include values of exclusively those telemetry parameters that are utilized during the training of the ML model.

In more embodiments, the process 600 may validate the trained ML model based on the predicted device power consumption and a power consumption value of the test dataset (block 640). For example, the trained ML model is validated based on a comparison of the predicted power and the power consumption value of the test dataset. The comparison result may indicate the accuracy of the prediction generated based on the trained ML model.

In additional embodiments, the process 600 may determine an error associated with the trained ML model (block 650). The error may correspond to the result of a comparison of the predicted power and the power consumption value of the test dataset. In many additional embodiments, the error may be MAPE. The error may be indicated as a percentage.

In further embodiments, the process 600 may determine whether the error is greater than a threshold value (block 655). In some examples, the threshold value may be 10%. However, other threshold values may also be possible. In still more embodiments, in response to determining that the error is greater than the threshold value (e.g., the error is not acceptable), the process 600 may again collect a base dataset associated with a network device (block 610). In other words, based on the determined error, the ML model may be tuned. The tuning may thus lead to a change in the determined error in subsequent iterations. The tuning may be executed until the error is less than or equal to the threshold value (e.g., the error is acceptable).

However, in still further embodiments, in response to determining that the error is less than or equal to the threshold value, the process 600 may use the ML model in the field (block 660). For example, if the error is less than or equal to the threshold value (e.g., the error is acceptable), the ML model may be configured to predict device power consumption based on device hardware telemetry data.

Although a specific embodiment for validating an ML model trained for power consumption prediction for carrying out the various steps, processes, methods, and operations described herein is discussed with respect to FIG. 6, any of a variety of systems and/or processes may be utilized in accordance with embodiments of the disclosure. For example, ML models with an error percentage greater than a tolerance limit (e.g., 20%) may be disregarded for implementation. The elements depicted in FIG. 6 may also be interchangeable with other elements of FIGS. 1-5, 7, and 8 as required to realize a particularly desired embodiment.

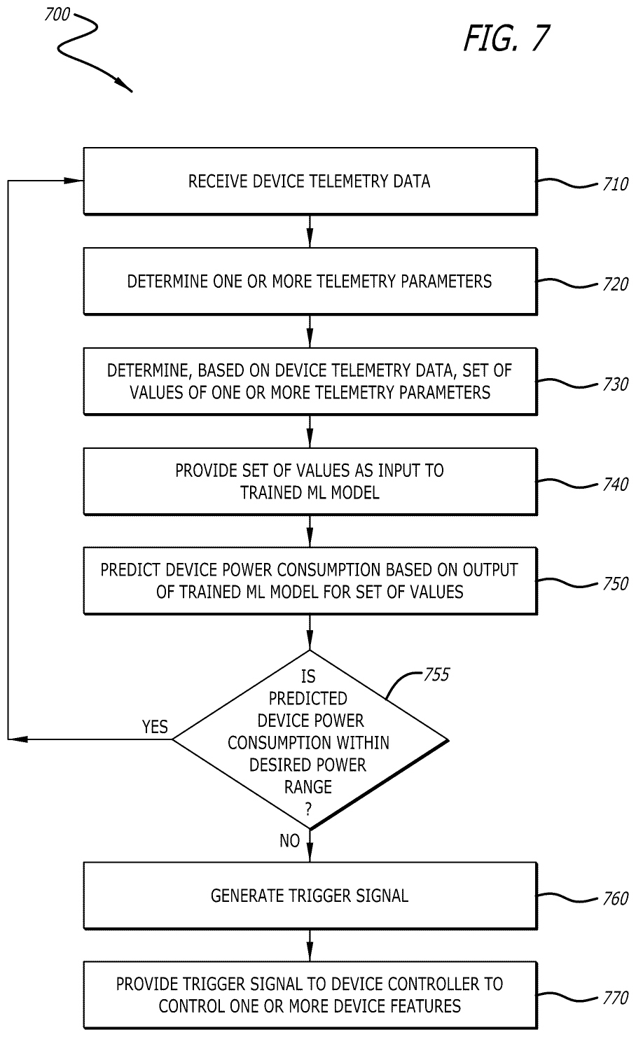

Referring to FIG. 7, a process 700 for predicting device power consumption in accordance with various embodiments of the disclosure is shown. In many embodiments, the process 700 may receive device telemetry data (block 710). In yet more embodiments, the device telemetry data may include a plurality of values of a motherboard temperature, a CPU temperature, a PSE junction temperature, a total memory capacity, a free memory capacity, an available memory capacity, and a CPU idle percentage, associated with a network device. Each value of the plurality of values may be timestamped.

In a number of embodiments, the process 700 may determine one or more telemetry parameters (block 720). The one or more telemetry parameters of the network device may correspond to model parameters that are utilized for training the ML model. In still yet more embodiments, the one or more telemetry parameters may include the motherboard temperature, the CPU temperature, the PSE junction temperature, the free memory capacity, a total CPU non-idle percentage, and a maximum CPU non-idle percentage. The total CPU non-idle percentage and the maximum CPU non-idle percentage may be generated based on the CPU idle percentage included in the device telemetry data.

In a variety of embodiments, the process 700 may determine, based on the device telemetry data, a set of values of the one or more telemetry parameters (block 730). Thus, the set of values may be obtained from the plurality of values (e.g., may be a subset of the plurality of values). The determined set of values may be utilized for predicting power consumed by the network device.

In more embodiments, the process 700 may provide the set of values as an input to the trained ML model (block 740). The ML model may be trained to determine the correlation between the device power consumption and the device telemetry. The trained ML model may provide an output based on the set of values.

In additional embodiments, the process 700 may predict the device power consumption based on the output of the trained ML model for the set of values (block 750). In many further embodiments, the power consumption may be predicted in real time. In many additional embodiments, the device telemetry data may be buffered and the power consumption of the network device may be predicted for a historical time instance using the buffered device telemetry data.

In further embodiments, the process 700 may determine whether the predicted device power consumption is within a desired power range (block 755). In still more embodiments, in response to determining that the predicted device power consumption is within the desired power range, the process may again receive device telemetry data (block 710). Such predicted power values can be configured to indicate that the network device is operating in a desired state.

However, in still further embodiments, in response to determining that the predicted device power consumption is outside the desired power range, the process 700 may generate a trigger signal (block 760). The trigger signal may be configured to indicate that the power consumption of the network device is outside the desired power range. The trigger signal can be utilized for taking corrective actions to bring the power consumption within the desired power range.

In still additional embodiments, the process 700 may provide the trigger signal to a device controller to control one or more device features (block 770). In still yet further embodiments, the controlling of a device feature may correspond to the activation of the device feature. In still yet additional embodiments, the controlling of a device feature may correspond to the deactivation of the device feature. In several embodiments, the controlling of a device feature may correspond to altering the intensity of the device feature. In several more embodiments, the device features may correspond to various hardware and software features (e.g., access ports, interfaces, communication protocols, blinking lights, switching mechanisms, security techniques, quality of service, or the like). The one or more device features may thus be controlled based on the predicted device power consumption.

Although a specific embodiment for predicting device power consumption is described above with respect to FIG. 7, any of a variety of systems and/or processes may be utilized in accordance with embodiments of the disclosure. For example, the prediction may be executed on the network device or off-device (e.g., in a remote device). The elements depicted in FIG. 7 may also be interchangeable with other elements of FIGS. 1-6 and 8 as required to realize a particularly desired embodiment.

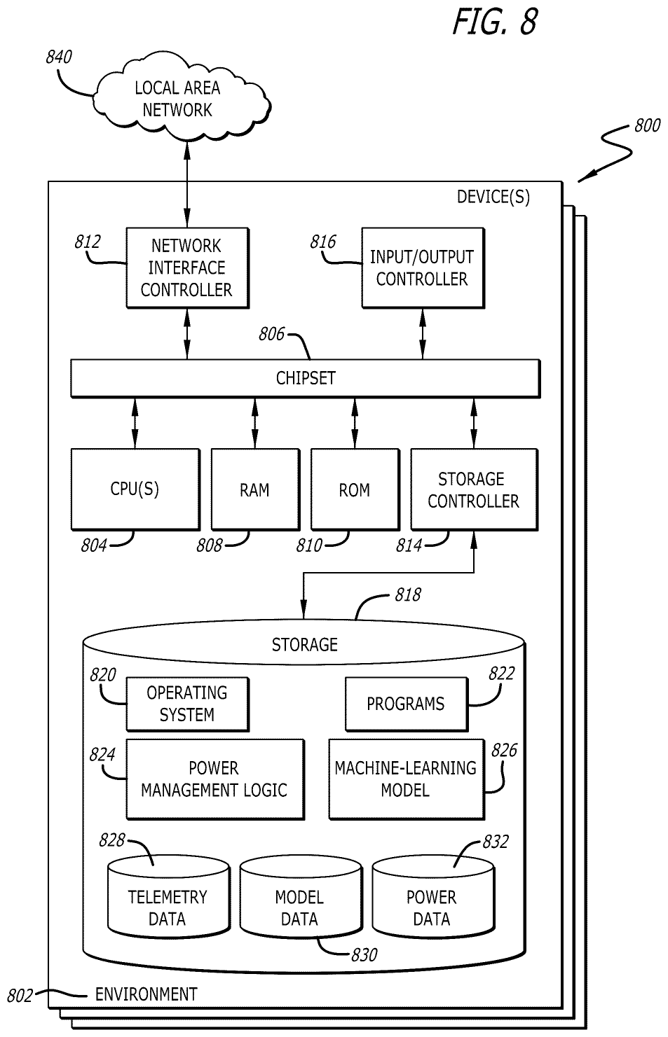

Referring to FIG. 8, a conceptual block diagram for one or more devices 800 capable of executing components and logic for implementing the functionality and embodiments described above is shown. The embodiment of the conceptual block diagram depicted in FIG. 8 can illustrate a conventional server computer, workstation, desktop computer, laptop, tablet, network appliance, e-reader, smartphone, or other computing device, and can be utilized to execute any of the application and/or logic components presented herein. The device 800 may, in some examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, CPUs, can be configured to operate in conjunction with a chipset 806. The processor(s) 804 can be standard programmable CPUs that perform arithmetic and logical operations necessary for the operation of the device 800.

In additional embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 806 may provide an interface between the processor(s) 804 and the remainder of the components and devices within the environment 802. The chipset 806 can provide an interface to RAM 808, which can be used as the main memory in the device 800 in some embodiments. The chipset 806 can further be configured to provide an interface to a computer-readable storage medium such as read-only memory (“ROM”) 810 or Non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Different embodiments of the device 800 can be configured to operate in a networked environment using logical connections to remote computing devices and computer systems through a network, such as the network 840. The chipset 806 can include functionality for providing network connectivity through a network interface controller (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for example, store an operating system 820, applications 822, and data 828, 830, and 832, which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

For example, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In various embodiments, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In more embodiments, the device 800 can also include computer-readable storage media having instructions stored thereupon for performing any of the other computer-implemented operations described herein.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8, and can include other components that are not explicitly shown in FIG. 8, or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more VMs running on the device 800 to perform functions described herein. The virtualization layer may generally support a virtual resource that performs at least a portion of the techniques described herein.

In many embodiments, the device 800 can include a power management logic 824 that can be configured to perform one or more of the various steps, processes, operations, and/or other methods that are described above. Often, the power management logic 824 can be a set of instructions stored within a non-volatile memory that, when executed by the processor(s)/controller(s) 804 can carry out these steps, etc. In some embodiments, the power management logic 824 may be a client application that resides on a network-connected device, such as, but not limited to, a server, switch, personal or mobile computing device, or an access point.

In certain embodiments, the power management logic 824 can collect a base dataset associated with a network device. The base dataset may include a plurality of values of power consumption and a set of telemetry parameters associated with a network device collected over a time period. The power management logic 824 may generate one or more engineered parameters based on at least one of the set of telemetry parameters. Further, the power management logic 824 may select a set of model parameters for model development. The power management logic 824 may determine a training dataset and a test dataset from the base dataset (e.g., the processed dataset). The training and test datasets may include one or more values of the power consumption and the set of model parameters associated with the network device collected over the time period. The power management logic 824 may train an ML model based on the training dataset for device power consumption prediction. The power management logic 824 may also validate the trained ML model based on the test dataset.

During an implementation phase, the power management logic 824 may receive device telemetry data associated with a network device deployed in the field. Based on the device telemetry data, the power management logic 824 may determine a set of values of one or more telemetry parameters. The one or more telemetry parameters may include the set of model parameters utilized for training the ML model. The power management logic 824 may provide the set of values as an input to the trained ML model and predict the power consumption of the network device based on an output of the trained ML model for the set of values. One or more device features may be controlled based on the predicted device power consumption.

In a number of embodiments, the storage 818 can include telemetry data 828. The telemetry data 828 may be associated with a network device. The telemetry data may indicate at least one of device performance and device physical condition. In an example, the telemetry data may include values of a motherboard temperature, a CPU temperature, a PSE junction temperature, a total memory capacity, a free memory capacity, an available memory capacity, and a CPU idle percentage, associated with the network device.

In various embodiments, the storage 818 can include model data 830. The model data 830 may include training and test datasets. Further, the model data may include one or more engineered parameters, data associated with linear models used for feature engineering, AIC values, aR2 values, and model hyperparameters.

In a number of embodiments, the storage 818 can include power data 832. The power data 832 may include the power values predicted by the ML model during the validation phase. The power data 832 may additionally include the power values predicted using the ML model for network devices deployed in the field.

Finally, in many embodiments, data may be processed into a format usable by an ML model 826 (e.g., feature vectors), and or other processing techniques. The ML model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826. The ML model 826 may be configured to learn the correlation between the device power consumption and the device telemetry data and predict the power consumption of a device deployed in the field based on the device's telemetry. Additionally, the ML model 826 may be configured to learn telemetry measurement timing patterns based on data related to historical measurements, and predict a possible time misalignment. Such predictions may be utilized to further improve the accuracy of telemetry data measurements, and in turn, the power predictions.

The ML model(s) 826 can be configured to generate inferences to make predictions or draw conclusions from data. An inference can be considered the output of a process of applying a model to new data. This can occur by learning from data and using that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although a specific embodiment for a device suitable for configuration with a power management logic for carrying out the various steps, processes, methods, and operations described herein is discussed with respect to FIG. 8, any of a variety of systems and/or processes may be utilized in accordance with embodiments of the disclosure. For example, the device 800 may be in a virtual environment such as a cloud-based network administration suite, or it may be distributed across a variety of network devices or switches. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor; and
a memory communicatively coupled to the processor, wherein the memory comprises a power management logic that is configured to:
collect a base dataset associated with a network device, wherein the base dataset comprises a plurality of values of power consumption and a set of telemetry parameters associated with the network device collected over a time period;
determine a training dataset from the base dataset; and
train a machine learning model based on the training dataset, wherein the trained machine learning model is configured to predict device power consumption based on device telemetry data.

2. The device of claim 1, wherein the base dataset is collected based on one or more testing operations.

3. The device of claim 2, wherein the one or more testing operations are executed sequentially, and in each testing operation of the one or more testing operations, a set of values of the power consumption and the set of telemetry parameters is collected.

4. The device of claim 3, wherein at least one of the set of values is timestamped.

5. The device of claim 2, wherein the one or more testing operations are associated with variations in at least one of memory consumption, temperature, central processing unit (“CPU”) load, and power over Ethernet (“PoE”) draw associated with the network device.

6. The device of claim 1, wherein the set of telemetry parameters comprises at least one of: a motherboard temperature, a CPU temperature, a power sourcing equipment (“PSE”) junction temperature, a total memory capacity, a free memory capacity, an available memory capacity, and a CPU idle percentage, associated with the network device.

7. The device of claim 1, wherein the power management logic is further configured to:
execute one or more processing operations on the base dataset; and
generate a processed dataset based on the execution of the one or more processing operations, wherein the training dataset is a subset of the processed dataset.

8. The device of claim 1, wherein the power management logic is further configured to:
generate one or more engineered parameters based on at least one of the set of telemetry parameters; and
select a set of model parameters that comprises the one or more engineered parameters and a subset of telemetry parameters of the set of telemetry parameters, wherein the training dataset comprises one or more values of the power consumption and the set of model parameters associated with the network device collected over the time period.

9. The device of claim 1, wherein the training dataset comprises one or more values of the power consumption and at least one of: a motherboard temperature, a CPU temperature, a PSE junction temperature, a free memory capacity, a total CPU non-idle percentage, and a maximum CPU non-idle percentage, associated with the network device collected over the time period.

10. The device of claim 9, wherein the set of telemetry parameters comprises a CPU idle percentage, and wherein the total CPU non-idle percentage and the maximum CPU non-idle percentage are determined based on the CPU idle percentage.

11. The device of claim 1, wherein the power management logic is further configured to:
determine a test dataset from the base dataset; and
validate the trained machine learning model based on the test dataset.

12. The device of claim 11, wherein the power management logic is further configured to predict power consumed by the network device based on a set of telemetry values derived from the test dataset, and wherein the trained machine learning model is validated based on the predicted power and a power consumption value of the test dataset.

13. The device of claim 11, wherein the power management logic is further configured to determine an error associated with the trained machine learning model based on the validation of the trained machine learning model.

14. The device of claim 13, wherein the power management logic is further configured to tune the machine learning model based on the determined error.

15. A device, comprising:
a processor;
a network interface controller configured to provide access to a network; and
a memory communicatively coupled to the processor, wherein the memory comprises a power management logic that is configured to:
receive device telemetry data;
determine, based on the device telemetry data, a set of values of one or more telemetry parameters;
provide the set of values as an input to a trained machine learning model; and
predict device power consumption based on an output of the trained machine learning model for the set of values.

16. The device of claim 15, wherein the device telemetry data is configured to indicate at least one of device performance and device physical condition.

17. The device of claim 15, wherein the device telemetry data comprises a plurality of values of at least one of: a motherboard temperature, a central processing unit (“CPU”) temperature, a power sourcing equipment (“PSE”) junction temperature, a total memory capacity, a free memory capacity, an available memory capacity, and a CPU idle percentage.

18. The device of claim 15, wherein the one or more telemetry parameters comprise at least one of: a motherboard temperature, a CPU temperature, a PSE junction temperature, a free memory capacity, a total CPU non-idle percentage, and a maximum CPU non-idle percentage.

19. The device of claim 15, wherein one or more device features are controlled based on the predicted device power consumption.

20. A method, comprising:
collecting a base dataset associated with a network device, wherein the base dataset comprises a plurality of values of power consumption and a set of telemetry parameters associated with the network device collected over a time period;
determining a training dataset from the base dataset; and
training a machine learning model based on the training dataset, wherein device power consumption is predicted by the trained machine learning model based on device telemetry data.
